(19) United States
(12) Patent Application Publication
(10) Pub. No.: US 2005/0094733 A1
(43) Pub. Date: May 5, 2005

(54) Fast channel surfing

(76) Inventor: Piers J. Daniell, Fort Collins, CO (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/699,044

(22) Filed: Oct. 31, 2003

(51) Int. Cl. H04N 7/12

(52) U.S. Cl. 375/240.25; 375/240.12

(57) ABSTRACT

Digital television having improved channel surfing ability. At least the “I” and “P” frames of an MPEG transport stream are buffered for as many program streams as memory permits. A pointer tracks where the last “I” frame of each program stream is in memory. Since the last “I” frame and subsequent “P” frames of a program stream are available, channel changes within the current MPEG transport stream are speed up by allowing any “P” frame to start a newly selected program stream. Extra memory enables buffering of all of the “I”, “P” and “B” frames of a program stream. Extra tuners can enable selection of multiple MPEG transport streams. Intelligent choices of MPEG transport streams can speed surfing across transport streams.

### BACKGROUND OF THE INVENTION

1. Field of the Invention

This invention generally relates to digital televisions. More particularly, this invention relates to digital television systems having improved channel changing (surfing) capabilities.

2. Description of the Related Art

Digital cable and digital satellite television viewers know how painfully slow it can be to change channels. With analog receivers it is possible to “channel surf” very quickly by repeatedly pressing the “Channel Up” or “Channel Down” button on a remote control. Indeed, some analog users enjoy channel surfing as much as or more than actual channel content. A major complaint with digital systems is that one cannot channel surf without significant delays between channels and/or broken images that take a second or so to rectify after changing channels. These problems can seriously detract from the user experience.

The reason digital television channel surfing is a problem relates to how digital images are formed and transmitted. While both analog and digital televisions operate by tuning and demodulating incoming RF (radio frequency) signals, with analog television a particular RF signal is associated with only one channel. However, in digital television each RF signal can contain several “channels,” better thought of as program streams, of information. Thus, with digital television a single tuner can tune a single frequency and receive multiple program streams. Those program streams are embedded in an MPEG (Motion Pictures Expert Group) transport stream. It is left to the remainder of the digital receiver to isolate the desired program stream and then display that content.

The MPEG encoding format uses three types of video frames, which are identified as “I”, “P” and “B”. An “I” frame represents a complete full-screen image. A “P” frame contains just the changes that need to be made to a previous “I” frame or “P” frame. By sending only the changes from a previous frame instead of the entire image far less image data needs to be sent. A “B” frame is similar to a “P” frame except that it describes changes from a previous and/or a following “I” or “P” frame. It should be understood that to use a “B” frame a subsequent “I” or “P” may be required. To produce continuous content the image frames are buffered to form a Group of Pictures (GOP), which represent all of the image frames from one “I” frame to the next. An example of a GOP is the set IBBBPBBBPBBBP.

To present a complete image an “I” frame must be available. In fact, all “P” and “B” frames are usually discarded until the first “I” frame is received. Once an “I” frame arrives the program's video frames can be composed and displayed. Typically an “I” frame arrives once a second or so, but with highly compressed video data an “I” frame may come less frequently, perhaps once every 3 seconds or so. The fact that an “I” frame is required after changing a channel is a major cause of the problems with channel surfing. To speed up channel changing some digital systems do not wait for an “I” frame and proceed by using a “P” frame. This is what causes the broken images since not all of the image data is available.

Therefore, digital receivers having improved channel surfing capability would be beneficial. In particular, digital receivers that can switch “channels” (program streams) faster and without broken images would be desirable.

### SUMMARY OF THE INVENTION

The principles of the present invention generally provide for an improved user experience by enabling digital televisions having improved channel surfing capability. By using the principles of the present invention, channel surfing can be performed faster and without broken images.

In one embodiment of the present invention a digital television includes a tuner and associated circuitry for receiving an MPEG transport stream having at least one program stream comprised of “I”, “P” and “B” frames. A transport stream decoder decodes the MPEG transport stream into a program stream. A program stream memory buffers at least the “I” and “P” frames of the program stream. An “I” frame tracker tracks the location in the program stream memory of the last “I” frame of the program stream. A program selector selects the buffered “I” and “P” frames beginning from the “I” frame of the program stream tracked by the “I” frame tracker and produces a sequence of frames starting from that last “I” frame. Associated circuitry then displays the content represented by the sequence of frames.

In another embodiment of the present invention a digital television includes first and second tuners for receiving first and second MPEG transport streams having at least first and second program streams that are comprised of “I”, “P” and “B” frames. First and second transport stream decoders decode the MPEG transport stream into the first and second program streams. First and second program stream memories buffer at least the “I” and “P” frames of the first and second program streams. An “I” frame tracker tracks the locations in the first and second program stream memories of the last “I” frames of the first and second program streams. A channel controller (such as a remote control) controls a program selector that selects buffered “I” and “P” frames from either the first or from the second program stream memories. The program selector receives the location of the last “I” frame of the program stream in the selected program stream memory from the “I” frame tracker when the program stream is selected. The program selector and associated circuitry then produce a sequence of frames starting from the last “I” frame of the program stream in the selected program stream memory. A display then produces the content represented by the sequence of frames.

In another embodiment of the present invention a digital television includes a tuner for receiving an MPEG transport stream having first and second program streams that are comprised of “I”, “P” and “B” frames. A first program stream memory buffers the “I” and “P” frames of the first program stream while a second program stream memory buffers the “I” and “P” frames of the second program stream. An “I” frame tracker tracks the locations in the first and second program stream memories of the last “I” frames of the first and second program streams. A channel controller controls a program selector that selects buffered “I” and “P” frames from either the first or from the second program memories. The program selector receives the location of the last “I” frame of the program stream in the selected program memory from the “I” frame tracker and then produces a sequence of frames starting from the last “I” frame of the program stream in the selected program stream memory. A display then produces the content represented by the sequence of frames.

The principles of the present invention further provide for an electronic program guide that define what channel is considered UP from the current channel and which channel is considered DOWN. Additionally, the principles of the present invention further provide for limiting channel surfing to a maximum rate so as to avoid broken images.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a digital television that is in accord with the principles of the present invention;

FIG. 2 illustrates a prior art digital television;

FIG. 3 schematically illustrates selecting a program stream in a first embodiment digital television that is in accord with the principles of the present invention;

FIG. 4 schematically illustrates selecting a program stream in a second embodiment digital television that is in accord with the principles of the present invention; and

FIG. 5 schematically illustrates selecting a program stream in a third embodiment digital television that is in accord with the principles of the present invention;

To facilitate understanding, identical reference numerals have been used, wherever possible, to designate identical elements that are common to the figures.

### DETAILED DESCRIPTION OF THE PREFERRED EMBODIMENT

The principles of the present invention provide for digital televisions having improved channel surfing with increased channel changing speeds and without broken images. A digital television that is in accord with the present invention includes additional memory and/or at least two tuners. The invention takes advantage of how digital content data is delivered to provide a better user experience.

According to the principles of the present invention extra tuners and/or extra memory improve the user's channel surfing experience. Depending on how many tuners there are and how much memory is available, channel changes can be made consistently fast. By tracking the memory locations of the “I” frames, and then by jumping directly to the “I” frame of a selected program stream, the display content is almost immediately available and broken images are eliminated. By buffering one or more channels directly above and directly below the channel currently being watched, both UP and DOWN channel surfing is enabled. Whenever an “I” frame arrives, the program stream buffering starts and an entire GOP can be captured. When the next “I” frame arrives, the next GOP is buffered and the previous GOP is cleared.

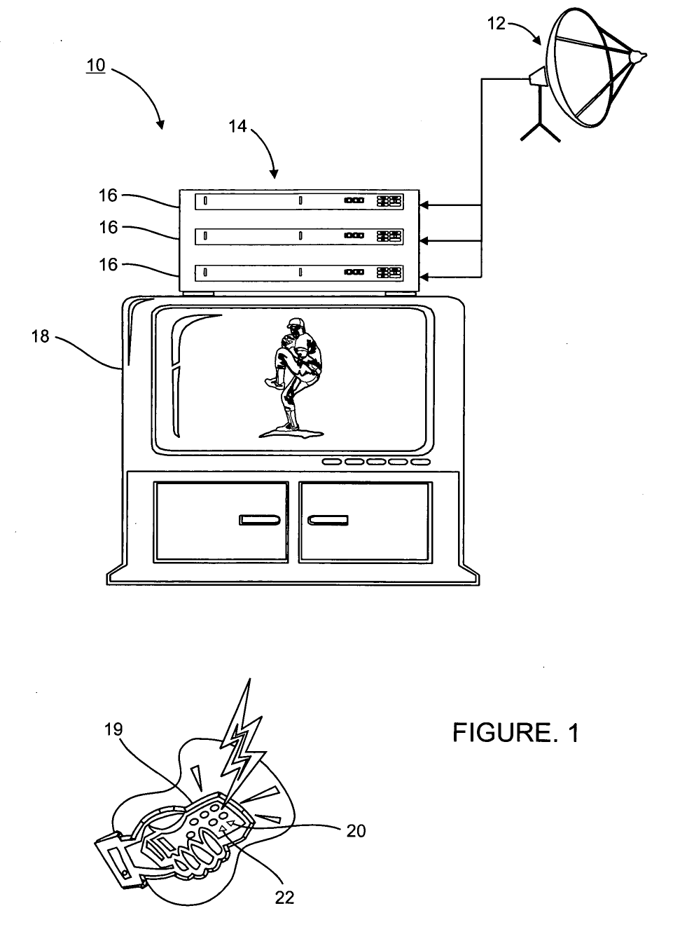

FIG. 1 illustrates a digital television 10 that is connected to a satellite receiver 12. The RF output of the satellite receiver 12 is applied to a front end 14 having a plurality of tuner systems 16. Typically, the front end 14 would be enclosed within the digital television 10, but the front end 14 shown separately because of its importance. The tuner systems 16 act under the control of a remote control 19 to select a content that is shown on a display 18. While FIG. 1 specifically shows a remote control 19, in general channels can be selected by any number of methods, including television channel changers, timers, remote controls, remote signalers or other devices. Those devices are generically referred to as channel changers.

The remote control 19 includes an UP button 20 and a DOWN button 22. The digital television 10 is specially configured to improve a user's viewing experience when the user channel surfs UP and/or DOWN using the buttons 20 and 22.

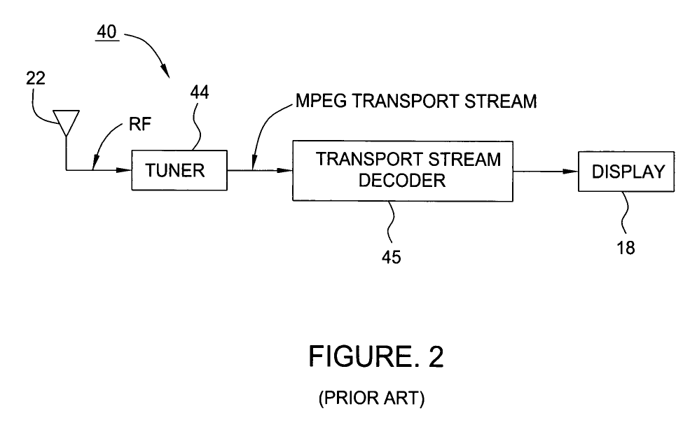

FIG. 2 illustrates a prior art digital television 40. That receiver receives RF signals on an antenna 22. The RF signals are applied to a tuner 44 that converts the RF signals into an MPEG transport stream that is applied to a transport stream decoder 45. The MPEG transport stream has one or more content “channels” in the form of program streams. That is, the MPEG transport stream may contain content multiple program streams and thus more than one channel. The MPEG transport stream applied to the transport stream decoder 45 which selects a “channel” for decoding. The decoded program stream is applied to a display 18 that plays the selected program stream.

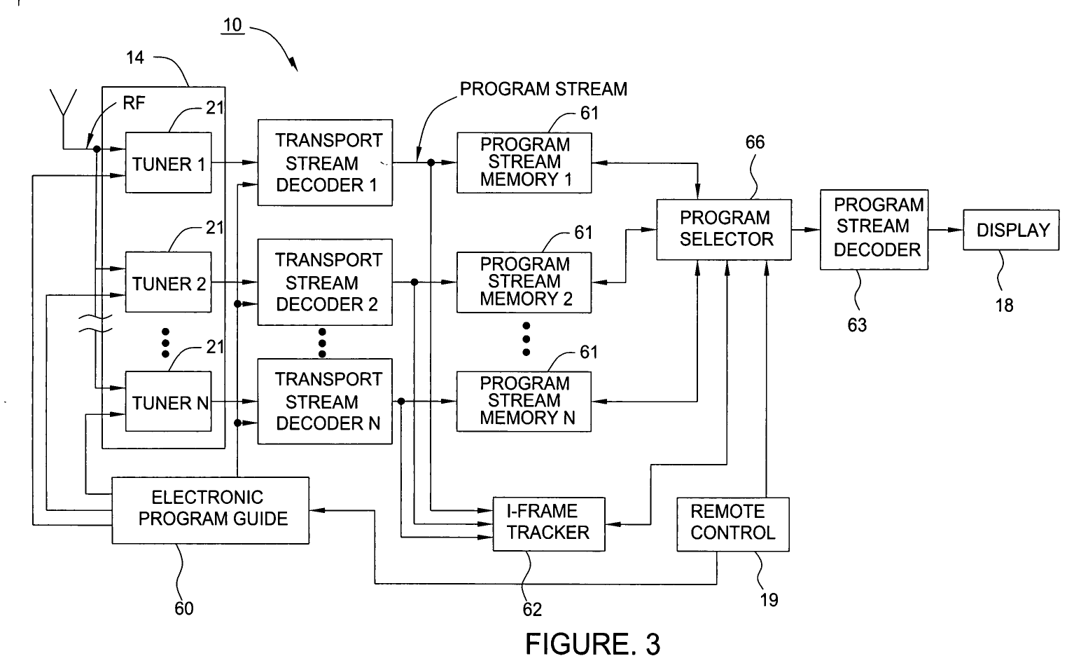

FIG. 3 illustrates how a first embodiment digital television, specifically the digital television 10 shown in FIG. 1, selects a program stream for display. The satellite receiver 12 (see FIG. 1) produces RF signals that are applied to the front end 14. While in FIG. 1 the front end 14 has three tuners 16, in general there can be N tuners, and thus FIG. 3 shows N tuners, which are labeled as tuner 1, tuner 2, . . . tuner N. The tuners tune the RF signals and apply the resulting MPEG transport streams to transport stream decoder 1, transport stream decoder 2, and transport stream decoder N, respectively. The tuners and transport stream decoders operate in accord with channel information from an electronic program guide 60. The electronic program guide 60 identifies what the next UP channel is and what the next DOWN channel is. This is required because in digital television what a viewer thinks the next UP (DOWN) channel is depends not on frequency or on the sequence of MPEG transport streams, but on what a program listing says the next UP (DOWN) channel is. For example, channel 2 might be the second program stream on one RF frequency, channel 3 might be the third program stream on another frequency, and channel 4 might be the first program stream on the first frequency. In any event, the electronic program guide 60 synchronizes the operation of the tuners and transport stream decoders with a program listing and with the UP (DOWN) buttons on the remote control 19.

The outputs of the transport stream decoders are program streams that are stored in associated program stream memories 61. That is, the output of transport stream decoder 1 is stored in program stream memory 1; the output of transport stream decoder 2 is stored in program stream memory 2; and the output of transport stream decoder N is stored in program stream memory N. Furthermore, the location of the last “I” frame of each program stream is stored in an “I” frame tracker 62. Thus, the “I” frame tracker 62 identifies the start of a GOP in each program stream memory.

The output of each program stream memory is applied to a program selector 66. When the remote control 19 signals a new channel, for example, when the UP button 20 is pressed, the remote control 19 informs the program selector 66 to select the next UP channel's program stream. The program selector 66 obtains the last “I” frame address of the next UP channel from the “I” frame tracker 62. The program selector 66 then jumps to the next UP channel's GOP start, specifically to the last “I” frame's address, and begins applying the selected transport stream to a program stream decoder 63 that decodes the selected program stream. The output of the program stream decoder 63 is applied to the display 18 (which, for simplicity, is assumed to include the required electronics and systems to produce an image from the output of the program stream decoder 63). In addition, the electronic program guide 60 determines the next UP channel and causes the tuners and transport stream decoders to obtain the next UP channel's program stream. A similar process works when the DOWN button 22 is pressed.

Intelligent choices should be made about which channels are buffered. While ideally all channels are buffered so that any change to any channel is instantaneous, in practice this may be prohibitively expensive. To improve “channel surfing” only a limited number of up/down channels actually need to be buffered. An electronic program guide such as reference 60 in FIG. 3 can control what the next channel is in each surfing direction. Improved surfing can be obtained by only buffering channels in one surf direction. For example, if the user is going up, up, up, it is better to buffer more UP channels and fewer down channels. In any event as soon as a channel is changed, program stream buffering should be adjusted to obtain a new program stream. The selection of which channels are buffered can dynamically depend on the usage pattern and buffer sizes. Alternatively, it is possible to only buffer program streams in one direction, thus limiting surfing to either UP or DOWN. This can be a particularly attractive option when limited tuner/decoders and limited memory is available.

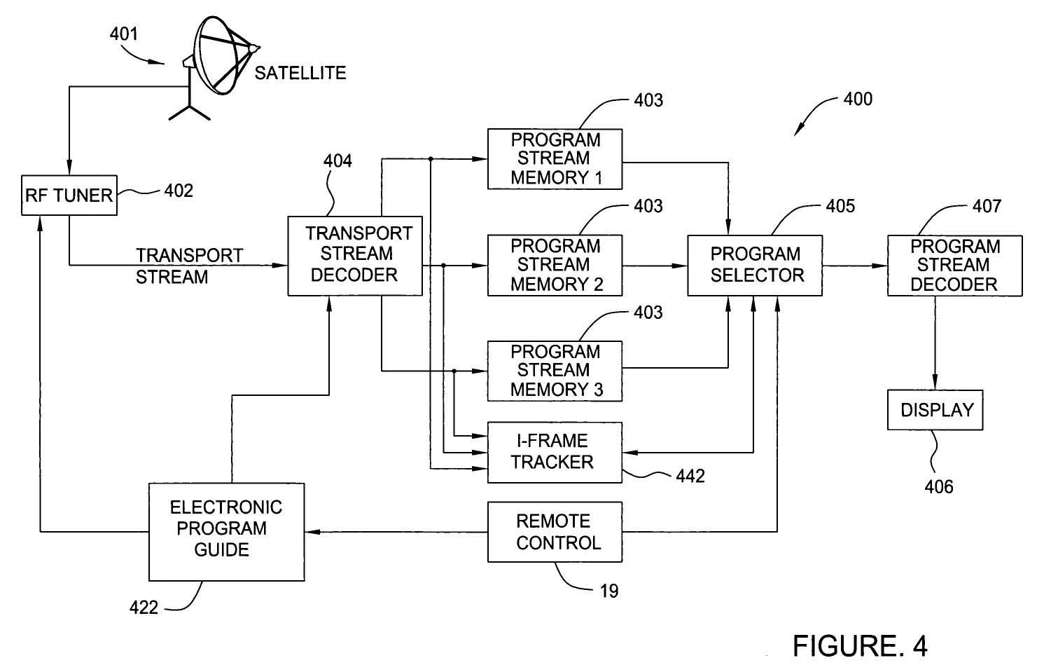

When memory is limited, the “I” and “P” frames can be buffered for as many program streams as memory permits. FIG. 4 illustrates such a limited memory digital television system 400. In particular, the system has a satellite receiver 401, and one RF tuner 402 that produces a single MPEG transport stream. The transport stream is applied to a transport stream decoder 404 that parses out the individual program streams from the MPEG transport stream. The individual program streams are applied to program stream memories 403, which are individually labeled program stream memory 1, program stream memory 2, and program stream memory 3. The program memories can store only “I” and “P” frames (if more memory is available then “B” frames can also be stored). The digital television system 400 also includes an electronic program guide 422 that synchronizes the operations of the RF tuner 402 and the transport stream decoder 404 with a program listing. Furthermore, the location of the last “I” frame of each program stream is stored in an “I” frame tracker 442. Thus, the “I” frame tracker 442 identifies the start of a GOP in each program stream memory.

A program selector 405, under the control of a remote control 19, selects the buffered program stream that is to be applied to a program stream decoder 407 and then to a display 406. Because the I-frame tracker 442 makes the location of the “I” frames available to the program selector 405, and because both “I” and “P frames are available, any “I”, “P” or “B” frame can start the video content. Of course, benefit is gained only if the UP/DOWN channel is contained within the current MPEG transport stream. This is not a particular problem for satellite or cable transmissions since a frequency change to select another MPEG transport stream will not likely be required.

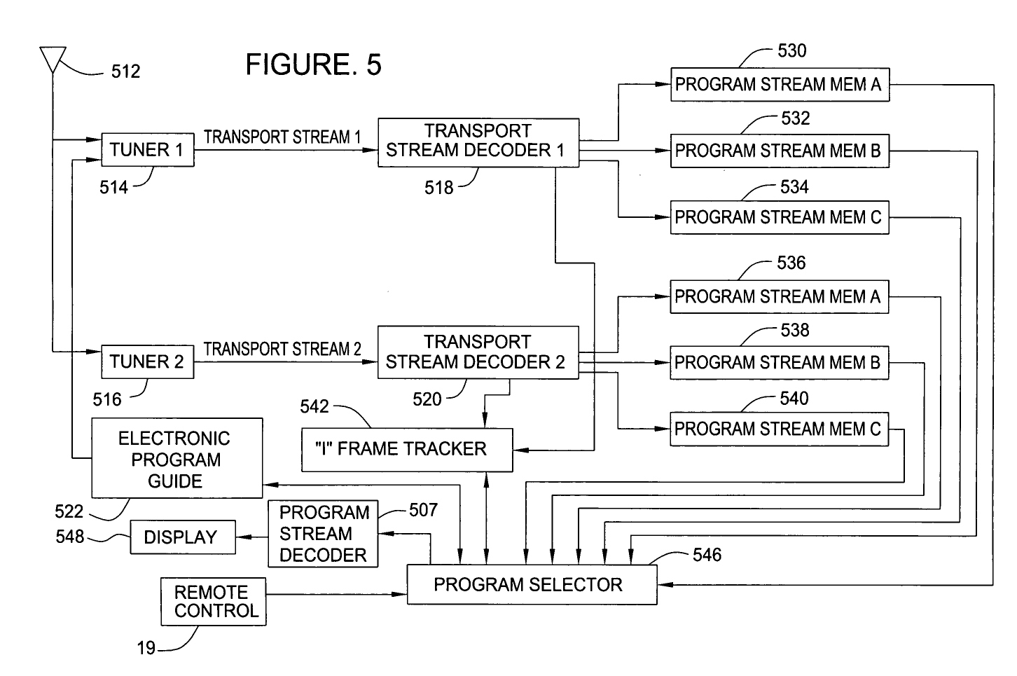

If a digital television is provided with an extra tuner the embodiment illustrated in FIG. 5 can be implemented. An antenna 512 produces RF signals that are applied to tuners 514 and 516. Tuner 514 produces an MPEG transport stream 1 that is applied to a transport stream decoder 518. Tuner 516 produces an MPEG transport stream 2 that is applied to a transport stream decoder 520. The transport stream decoders decode the MPEG transport streams into program streams. The tuners 514 and 516 operate in accord with channel information from an electronic program guide 522. The electronic program guide 522 synchronizes the operation of the tuners such that the next UP (DOWN) channel is available.

The transport stream decoders 518 and 520 separate the program streams from the MPEG transport streams. The program streams are buffered in program stream memories 530-540. Additionally, the “I” frames of the various program streams are stored in an “I” frame pointer memory 542. The program stream memories are connected to a program selector 546 that operates under control of a remote control 19 (in general, any type of channel changer is suitable). When the remote control 19 signals the program selector 546 to select the next channel (program stream) the channel selector 546 selects the next program stream from the proper stream memory and applies the corresponding GOP to a program stream decoder 507, and then to a display 548. The location of the start of the GOP, an “I” frame, is obtained from the “I” frame pointer memory 542. The channel change is also applied to the electronic program guide 522 which then causes another program stream to be made available.

While the foregoing has described various embodiment of the present invention, in general, the more tuners and memory there are the better the user experience. The more programs streams that are buffered, the faster the channels can change. After a channel is changed a new channel should be buffered so that the new channel's “I” frame is available before that new channel is selected.

Assuming that an “I” frame arrives every second and that there is sufficient memory to buffer 2 extra channels (UP and DOWN) then a new channel can be selected after about a second. For a given channel surfing direction, the following formulae can be used to calculate the worst-case continuous surfing speed:
N=Worst-case time between “I” frames;
Q=Number of channel buffers in the surfing direction
S=Worst-case continuous surfing speed in the surfing direction;
   Then, S=N/(Q+1)

In practice, a memory (buffer) should be able to hold up to 1 GOP of data. The number of program streams that can be buffered therefore depends on how much memory is available and on the size of the GOP. The GOP size depends on the bitrate of the buffered channel (program stream) and the number of frames in the GOP. Typically, low-quality channels have a lower bitrate, but the number of frames in a GOP is larger, so the buffer has to store many low-bitrate frames. For high-quality channels, the bitrate is higher, but there are usually fewer frames in the GOP. A dynamic memory model could be used to buffer the most possible channels using the available memory space.

While the foregoing is directed to embodiments of the present invention, other and further embodiments of the invention may be devised without departing from the basic scope thereof, and the scope thereof is determined by the claims that follow.

1. A digital television, comprising:
a tuner for receiving an MPEG transport stream having at least one program stream comprised of “I”, “P” and “B” frames;
a transport stream decoder for decoding said at least one program stream from said MPEG transport stream;
a program memory for buffering “I” and “P” frames of said at least one program stream;
an “I” frame tracker for tracking the memory location of the last “I” frame of said at least one program stream;
a program selector for selecting said buffered “I” and “P” frames from said program memory, wherein said program selector receives the location of the last “I” frame of said at least one program stream from said “I” frame tracker when the program is selected, and wherein said program selector outputs a sequence of frames starting from that last “I” frame;
a program stream decoder for decoding said sequence of frames; and
a display for imaging said decoded sequence of frames.

2. The television according to claim 1, further including a channel controller for selecting said sequence of frames.

3. The television according to claim 3, wherein the channel controller is a remote control.

4. A television according to claim 1, further including an electronic program guide for determining which program stream represents an adjacent channel.

5. A television according to claim 1, wherein said sequence of frames begins on an “I” frame.

6. A television according to claim 1, wherein said sequence of frames begins on a “P” frame.

7. A television according to claim 1, wherein said program memory further buffers “B” frames.

8. A television according to claim 1, wherein said sequence of frames begins on a “B” frame.

9. A digital television, comprising:
a first tuner for receiving a first MPEG transport stream having at least a first program stream comprised of “I”, “P” and “B” frames;
a first program memory for buffering “I” and “P” frames of said first program stream;
a second tuner for receiving a second MPEG transport stream having at least a second program stream comprised of “I”, “P” and “B” frames;
a second program memory for buffering “I” and “P” frames of said second program stream;
an “I” frame tracker for tracking the locations in said first and second program memories of the last “I” frames of both said first and second program streams;
a channel controller;
a program selector for selecting buffered “I” and “P” frames from either said first or from said second program memories, wherein said program selector's selection is based on signals from said channel controller, wherein said program selector receives the location of the last “I” frame of the program stream in said selected program memory from said “I” frame tracker, and wherein said program selector produces a sequence of frames starting from the last “I” frame of the program stream in said selected program memory;
a program stream decoder for decoding said sequence of frames; and
a display for producing content represented by said sequence of frames.

10. A television according to claim 9, wherein the first and second tuners include a decoder for decoding said first and second MPEG transport stream to form said first and second program streams.

11. A television according to claim 9, wherein said channel controller is a remote control.

12. A television according to claim 9, further including an electronic program guide for determining which program stream represents an adjacent channel.

13. A television according to claim 9, wherein said sequence of frames begins on an “I” frame.

14. A television according to claim 9, wherein said sequence of frames begins on a “P” frame.

15. A television according to claim 9, wherein said first and second program memories buffer “B” frames.

16. A television according to claim 9, wherein said sequence of frames begins on a “B” frame.

17. A digital television, comprising:
a tuner for receiving an MPEG transport stream having first and second program streams that are comprised of “I”, “P” and “B” frames;
a first transport stream decoder for decoding said first program stream from said MPEG transport stream;
a first program memory for buffering “I” and “P” frames of said first program stream;
a second transport stream decoder for decoding said second program stream from said MPEG transport stream;
a second program memory for buffering “I” and “P” frames of said second program stream;
an “I” frame tracker for tracking the locations in said first and second program memories the last “I” frames of said first and second program streams;
a channel controller;
a program selector for selecting buffered “I” and “P” frames from either said first or from said second program memories, where said program selector's selection is based on signals from said channel controller, wherein said program selector receives the location of the last “I” frame of the program stream in said selected program memory from said “I” frame tracker, and wherein said program selector produces a sequence of frames starting from the last “I” frame of the program stream in said selected program memory;
a program stream decoder for decoding said sequence of frames; and
a display for producing content represented by said sequence of frames.

18. A television according to claim 17, wherein the content represented by said sequence of frames begins on an “I” frame.

19. A television according to claim 17, wherein the content represented by said sequence of frames begins on a “P” frame.

20. A television according to claim 17, wherein the content represented by said sequence of frames begins on a “B” frame.
